(19) United States
(12) Patent Application Publication
(10) Pub. No.: US 2022/0161570 A1
(43) Pub. Date: May 26, 2022

(54) METHODS AND SYSTEMS FOR GENERATING VARIABLE DIGITAL OPTICAL IMAGES ON A SUBSTRATE USING A THERMAL HEAD

(71) Applicant: Nanografix Corporation, San Diego, CA (US)

(72) Inventor: Daniel LIEBERMAN, San Diego, CA (US)

(73) Assignee: Nanografix Corporation, San Diego, CA (US)

(21) Appl. No.: 17/531,500

(22) Filed: Nov. 19, 2021

Related U.S. Application Data
(60) Provisional application No. 63/117,700, filed on Nov. 24, 2020.

(51) Int. Cl. B41J 2/335

(52) U.S. Cl. CPC B41J 2/33515

(57) ABSTRACT

A thermal printer comprising a thermal head including an array of heating elements disposed on the thermal head, the array of heating elements including optical structures comprising an array of first pixels corresponding to a first color and second pixels corresponding to a second color, the first color being different from the second color; wherein individual ones of the pixels comprise sub-pixels, a given pixel comprising a first sub-pixel and a second sub-pixel, the first sub-pixel comprising a first optical structure corresponding to light to be reflected or transmitted from a substrate toward a left eye of a person from a first viewing angle, the second sub-pixel comprising a second optical structure corresponding to light to be reflected or transmitted from a substrate toward a right eye of the person from the first viewing angle, and the first sub-pixel and the second sub-pixel correspond to the color of light of the given pixels to be reflected or transmitted from a substrate.

This invention generally relates to methods and systems for producing variable digital optical images and optical encrypted information on a substrate using a thermal head. More particularly, in a thermal printer, a thermal head has addressable thermal elements that have optical structures formed by surface reliefs. The surface reliefs may be optical structures such as gratings, holograms, photonic structures or any other optical structure that is made from surface reliefs. The reliefs, when pressed into or against a substrate will generate an optical image in the substrate such as a holographic effect, a stereo effect, an optical effect, an optically variable security encrypted information. The optical images may vary with every print cycle.

### BACKGROUND

Optical images that create two-dimensional and/or three-dimensional effects may typically be produced by printing, embossing or engraved on substrates using lenticular and integral lens techniques, microlens sets array techniques, holographic techniques, electro beam techniques, specular techniques, dot matrix techniques, light field techniques, electron beam techniques and/or stereographic techniques. These techniques create surface reliefs that are replicated in a substrate or one or more layers or coatings on the substrate.

A need has arisen in the printing industry for the capability of generating two-dimensional and/or three-dimensional effects on a substrate or one or more layers or coatings on the substrate at low cost and of integrating them into conventional printing machinery so that they can easily be incorporated in printed materials such as labels, laminates, packaging, security documents, identification documents, lottery tickets and/or other printed materials.

Direct thermal printing and thermal transfer printing are well-known digital printing processes that use a thermal head to produce images on a substrate, such as in thermal paper or different papers and films with or without ribbons. Thermal printers used for these printing processes generally have the following primary components:
A thermal head, with heating elements—which generates heat and prints on the paper
A platen—which is a rubber roller that feeds paper
A spring—which applies pressure to the thermal head, causing it to contact the paper

Generally, a thermal head contains multiple thermal elements (resistors), also referred to as heating elements, that are used as heat sources for printing. The number, size and configuration of the heating elements vary depending on the needed resolution and usage conditions. A thermal head's heating elements are usually arranged as a line of small closely spaced areas on the thermal head. The number, spacing and size of the heating elements determines the resolution of the printer. The heating elements can be made in many different figures and dimensions such as dots, rectangular shapes, square shapes, etc. Thermal heads commonly have resolution of about 300 dots per inch (300 dpi), i.e., 300 heating elements per inch, but higher resolution thermal heads with resolution up to 1200 dpi are also known, and if thermal heads are placed in tandem, double the resolution can be achieved, e.g., two 1200 dpi heads placed in tandem can achieve 2400 dpi resolution. Generally, the printer sends an electric current to various specific heating elements of the thermal head.

In the direct thermal printing process a printed image is produced by selectively heating areas on a coated thermochromic paper, or thermal paper as it is commonly known, when the paper passes over the thermal head. The coating turns black in the areas where it is contacted by a heat source, such as a heated thermal element.

In order to print, thermo-sensitive paper is inserted between the thermal head and the platen. The printer sends an electric current to selected heating elements of the thermal head, which generate heat. The heat activates the thermo-sensitive coating or coloring of the layer of the thermosensitive paper, which changes color where heated. The thermal head heats specified heating elements based on data received from the printer in order to print a desired image or pattern to be produced.

In the thermal transfer printing process, the printer's thermal head also heats selected heating elements according to the image to be produced. However, the thermal transfer printing method also includes an additional component—a thermal print ribbon. In this method, an image is produced by melting (gluing) a wax or resin-based ink ribbon onto a material such as paper or films using heat and pressure. The ribbons can be made of any color, and may be transparent or UV, which can then be used, for example, for security purposes on a substrate.

While direct thermal printing and the thermal transfer printing can be used to print on thermo-sensitive substrates to create low cost labels, neither method has heretofore been used to create optical images in an embossable substrate having two-dimensional and/or three-dimensional effects.

### SUMMARY

One aspect of the invention includes a new thermal head (also sometimes referred to as a thermal printhead or printhead) for a thermal printer. The new thermal head has specially designed thermal elements that have optical structures formed by surface reliefs, which may be gratings, holograms or any other optical structure made from surface reliefs. The new thermal head may also be a high resolution thermal head, i.e., have a resolution of about at least 1200 dpi and up to 2400 dpi or more. The new thermal head can be used to create optical structures in a substrate that is embossable (i.e., one that can be embossed or imprinted). Embossable substrates may have one or more layers of an embossable material and/or an embossable coating. For example, an embossable substrate may include an embossable lacquer and may also include one or more of a vacuum deposited aluminum layer and/or HRI layer. An embossable substrate may also be made of a soft material, such as PVC, BOPP or OPP. The optical structures created in the substrate generate images with holographic effects, such as 2-dimensional and 3-dimensional effects, multi-color effects and stereo- and depth effects including sequential numbers, sequential QR codes, text and optical encrypted information.

Some implementations may enable the thermal printers to vary the optical image that is being printed. According to some implementations, they may facilitate creating optical structures in such a manner that they are variable, meaning that after individual printing cycles a new and different optical image can be instantly produced. For example, an optical image may change from label to label with a purpose of increasing security of the product on which the label has been adhered, and/or with a purpose of personalizing packaging with a unique optical characteristic for individual packages. This is digital printing of optical structures.

Some implementations may be used to produce optical structures continuously or on demand. As such, the cost of generating variable optical images in a substrate may be dramatically reduced.

In some implementations, thermal heads may have thermal elements with surface reliefs that relate to views from a person's left and right eye and also relate to color, such as red, green and/or blue, and can be used to create full color, 2D/3D, 3D optical images or images that have encrypted information. The surface reliefs may be optical structures, such as gratings, holograms, photonic structures or any other optical structure that is made from surface reliefs.

In some implementations, thermal heads may have engraved thermal elements with surface reliefs that are made by ion etching, chemical etching, laser engraving, or any other method that can be used to create surface reliefs in the element and the thermal head may have resolutions of between about at least about 300 dpi and up to about 2400 dpi or more.

In some implementations, embossable substrates may be film or paper with one or more layers or coatings of embossable material, and may be metallized or have a high refractive index. Embossable substrates may also be soft materials such as PVC, BOPP or OPP. Other embossable substrates can be used as well.

In some implementations the thermal head strikes the embossable side of the substrate in order to create the optical image or optical effect in the substrate. The image or effect can be created using a thermal head with or without a ribbon. The ribbon can also be transparent.

In some implementations two heads can be used in tandem in order to create optical images that have 2400 dpi resolution or greater on the substrate.

In some implementations variable optical images and information can be created and also encrypted information can be created. Variable information such as QR codes, sequential numbers, or text.

In some implementations the embossable substrate may also have one or more layers or a coating of a pressure sensitive material and can be pre-die cut into different shapes before entering the thermal printer.

In some implementations the embossable substrates can be pre-embossed with optical structures to create additional and novel optical effects in the substrate.

In another aspect, in a thermal transfer printer, the thermal transfer ribbon can have surface reliefs that form optical structures, such as pre-embossed RGB optical elements, and can be used to create optical images in a substrate with or without surface reliefs in the thermal head.

Another aspect of the present invention stems from the realization that thermal elements of existing thermal print systems have unintended surface reliefs or gratings formed therein. It has been discovered that an embossable substrate can be used in existing thermal printers such that the surface reliefs or gratings on the thermal elements can be used to create or replicate surface reliefs in the substrate which generate images with 2D and single color holographic effects. The holographic effects are obtained when the embossable substrate is fed into the printer in an orientation such that the substrate's embossable surface or area (e.g., embossable lacquer layer) can be contacted (directly or indirectly) by the thermal head.

Other advantages of the present invention will become readily apparent from the following detailed description. The invention is capable of other and different embodiments, and its several details are capable of modifications in various obvious respects, all without departing from the invention. Accordingly, the drawing and description are illustrative in nature, not restrictive.

### BRIEF DESCRIPTION OF THE DRAWINGS

The foregoing aspects and many of the attendant advantages of the disclosed embodiments will become more readily appreciated by reference to the following detailed description, when taken in conjunction with the accompanying drawings, wherein:

FIG. 1 depicts a system configured for fabricating variable digital optical images in a substrate a thermal printer, in accordance with one or more implementations.

FIG. 2 depicts a schematic diagram of a direct thermal print system configured for making variable digital optical images, in accordance with one or more implementations.

FIG. 3 depicts a schematic diagram of a thermal transfer print system configured for making variable digital optical images, in accordance with one or more implementations.

FIGS. 4A and 4B illustrate schematic diagrams of embossable substrates that can be used with the system of FIG. 2 or 3, in accordance with one or more implementations.

FIG. 5 illustrates a schematic diagram of a thermal head's heating element having a matrix of pixels corresponding to color and sub-pixels corresponding to non-color effects, in accordance with one or more implementations.

FIG. 6 also illustrates a schematic diagram of a thermal head matrix having pixels corresponding to color and sub-pixels corresponding to non-color effects, in accordance with one or more implementations.

FIG. 7 illustrates a schematic diagram of an exemplary array of thermal head heating elements, in accordance with one or more implementations.

FIG. 8 illustrates a schematic diagram of an exemplary array of thermal head heating elements with sub-pixels, in accordance with one or more implementations.

FIG. 9 illustrates an exemplary image formed in a substrate by a direct thermal printer, in accordance with one or more implementations.

FIG. 10 illustrates an exemplary image formed in a substrate by a thermal transfer printer, in accordance with one or more implementations.

FIG. 11 illustrates a flow diagram of a method for fabricating variable digital optical images using a thermal head, in accordance with one or more implementations.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details.

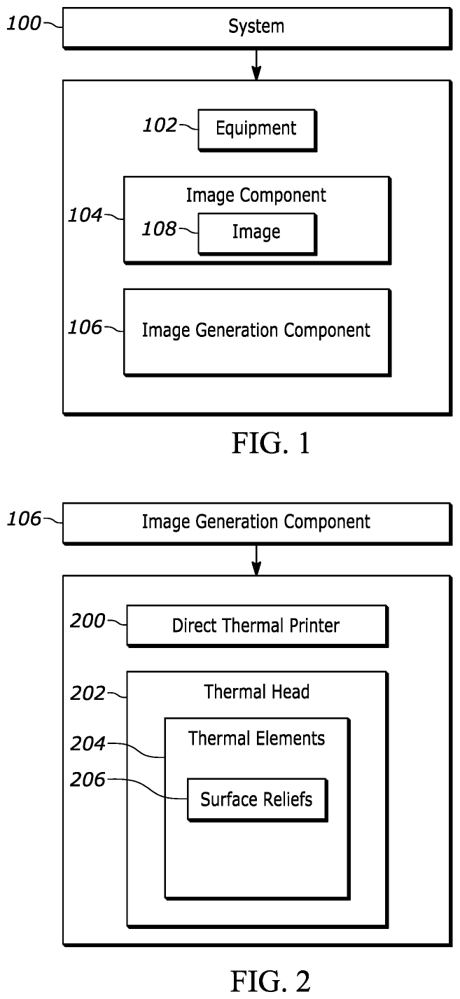

FIG. 1 illustrates a system 100 configured for fabricating variable digital optical images using thermal printing equipment, in accordance with one or more implementations. In exemplary implementations, system 100 may include equipment 102 including, one or more of: an image component 104, an image generation component 106, and/or other components. One or more components of system 100 may be included in equipment 102. Image generation component 106 may also include thermal printing equipment.

The image component 104 may be configured to retain an image 108 to be created or transferred to a substrate. The image 108 may include a physical likeness or representation of a person, animal, and/or thing that is photographed, painted, and/or otherwise made visible or may be a negative of such images. The image may also be a code or variable code, as described in more detail below.

According to various implementations, image 108 may be in an electronic format, as discussed further herein. As such, image component 104 may include electronic storage configured to store image 108 in an electronic format. The image component 104 may include one or more processors configured to provide information associated with image 108 to one or more other components of system 100. The image 108 may be based on a geometry associated with a matrix of thermal elements on a thermal printer thermal head, as described in more detail below.

One aspect of the invention includes a novel thermal head having a predetermined matrix of thermal elements with surface reliefs, that form optical structures such as, for example, gratings, that can be used to generate images with holographic effects (described in detail below) that cannot be generated by existing thermal printer thermal heads. In this aspect, the matrix of thermal elements may have thermal elements with surface reliefs, such as gratings, corresponding to color (pixels) and surface reliefs corresponding to non-color effects (sub -pixels). For example, the pixels may include first pixels corresponding to a first color and second pixels corresponding to a second color. The sub-pixels may include first sub-pixels corresponding to a first non-color effect and second sub-pixels corresponding to a second non-color effect.

Another aspect of the present invention stems from the realization that thermal heads of existing thermal print systems have unintended gratings or surface reliefs formed therein. It has been discovered that a substrate with a particular structure can be used in existing thermal printers such that the gratings on the thermal heads can be used to create or replicate surface reliefs in the substrate which generate images with 2D and single color holographic effects. The holographic effects are obtained when the substrate is fed into the printer in an orientation such that the embossable lacquer is in contact (directly or indirectly) with the thermal head.

FIG. 2 illustrates a direct thermal print system 200 that, in one implementation, can be used as an image generation component 106, to create an optical image on a substrate. The component has a thermal printer 200. The thermal printer 200 has a thermal head 202, with thermal heating elements 204 with optical structures formed by surface reliefs 206, such as, for example, gratings. Examples of thermal printers include thermal printers made by Zebra, Brother, Fargo, Epson, Seiko, and Dymo.

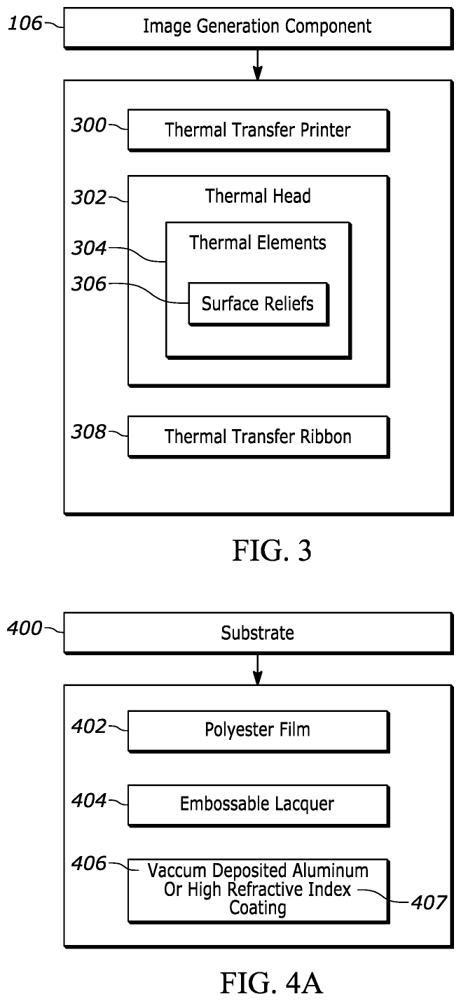

FIG. 3 illustrates thermal transfer print system 300 that, in one implementation, can be used as an image generation component 106, to create an optical image on a substrate. The component also has a thermal printer 300. The thermal printer 300 has a thermal head 302 with heating elements 304 having optical elements formed by surface reliefs 306, such as, for example, gratings. The printer 300 also has a thermal print ribbon 308. Examples of thermal transfer printers also include ones made by Zebra, Brother, Fargo, Epson, Seiko, and Dymo.

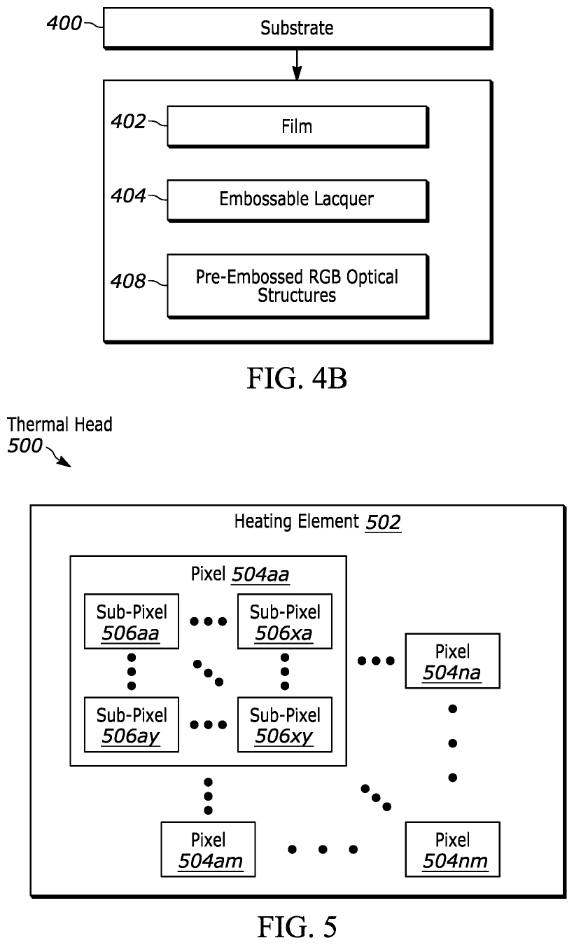

FIGS. 4A and 4B illustrate two examples of substrates 400 that can be used with the components of FIG. 2 or 3. As shown, in FIG. 4A, the substrate 400 has a polyester film 402, an embossable lacquer 404 and a vacuum deposited aluminum 406 or HRI coating 407 on the embossable lacquer 404. The embossable lacquer 404 is a lacquer in which an optical image can be created by application of heat and pressure. As shown, in FIG. 4B, the substrate 400 has a polyester film 402, an embossable lacquer 404 and one or more pre-embossed layers or coatings that have RGB optical structures 408 formed therein. The pre-embossed layers or coatings may be further embossable by the thermal head, as described herein.

When a thermal head's thermal elements contact or are pressed onto the embossable layer or layers directly (in the direct thermal printer example) or indirectly through the ribbon (in the thermal transfer printer example), the surface reliefs will form corresponding surface reliefs or optical reliefs in the substrate's embossable layer, e.g., embossable lacquer and/or aluminum or HRI coating, or both. This method of forming reliefs in an embossable substrate is sometimes commonly referred to as embossing or engraving. Other structures of the substrate and substrates with additional layers can be used as well, such as a substrate made of a soft material such as PVC, BOPP, OPP, which may be used with or without a separate embossable lacquer and/or the aluminum deposit. The substrate may also have one or more layers or a coating of a pressure sensitive material and can be pre-die cut into different shapes before entering the thermal printer. This is useful, for example, for creating labels with variable optical images.

Another aspect of the invention includes a new thermal head for a thermal printer. The new thermal head has thermal elements with specially designed surface reliefs, such as gratings, and can be used in a direct thermal printer or a thermal transfer printer. The thermal elements may have a resolution of at least about 300 dpi or more, including at least about 1200 dpi or 2400 dpi, which allows more advanced optical effects to be generated. Higher resolutions may be achieved by using more than one thermal heads in tandem, e.g., two 1200 dpi heads placed in tandem can achieve 2400 dpi resolution on a substrate. The thermal head 500, shown schematically in FIG. 5, can be used to create or replicate surface reliefs in a substrate that generates an image with various optical and holographic effects.

FIG. 5 illustrates schematically a thermal head 500 having a heating element 502. Of course the thermal head 500 will have many heating elements 502, but only one is shown here for illustration purposes. The heating element 502 has optical structures formed by surface reliefs that form a matrix of pixels 504 corresponding to color and sub-pixels 506 corresponding to non-color, in accordance with one or more implementations. The thermal head 500 may be made of any metal, but typically is made of nickel, stainless steel, or aluminum. The thermal head 500 may have a matrix of heating elements 502, each having surface reliefs that form optical structures that are pixels 504 and sub-pixels 506 etched into the thermal head's heating elements 502. The surface reliefs may be etched by various known processes, including a chemical process, a laser engraving process, nano lithography or an ion etching process. Some optical structures are pixels 504 that have a geometry such that they correspond to color and some optical structures are sub-pixels 506 that have a geometry that correspond to non-color effects.

The pixels 504 may be disposed on the thermal head 500 as an array. The total number of pixels 504 in the array may depend on the size of thermal element or heating element 502. For example, low resolution may be used for creating three-dimensional posters that can be seen at a given distance (e.g., one meter, two meters, ten meters, fifty meters, and/or other distances). High resolution may be used for creating labels with micro- or nano-texts, hidden images, and/or other security features. According to various implementations, the number of pixels 504 in the array may be hundreds, thousands, millions or other quantities. The array of pixels 504 may have a resolution in the range of about 300 dpi to about 1200 dpi (or more). The array of pixels 504 may be arranged as one or more of a square lattice, a hexagonal lattice, triangular lattice, rectangular lattice, a random or pseudorandom arrangement, and/or other arrangements. Individual ones of pixels 504 may be shaped as a circle, a square, a rectangle, a line, an oval, a rounded square, dots, and/or other shapes.

Different pixels 504 may correspond to different colors. That is, some of pixels 504 may correspond to pixels that are configured to create corresponding surface reliefs/optical structures in a substrate that reflect and/or transmit one color of light while other pixels 504 are configured to create corresponding surface reliefs/optical structures in a substrate that may reflect and/or transmit another color of light. The color of a given pixel may depend on an angle at which the given pixel is viewed in the substrate. For example, as a viewing angle changes, a color of light reflected or transmitted by the given pixel may change (e.g., by sweeping through the range of visible colors). In some implementations, the array may include first pixels 504 configured to create surface reliefs/optical structures in a substrate corresponding to a first color and second pixels 504 configured to create surface reliefs/optical structures in a substrate corresponding to a second color. The first color may be different from the second color. The array may further include third pixels 504 configured to create surface reliefs/optical structures in a substrate corresponding to a third color. The third color may be different from the first color and the second color. In some implementations, the array may further include fourth pixels 504 are configured to create surface reliefs/optical structures in a substrate corresponding to a fourth color. The fourth color may be different from the first color, the second color, and the third color. In sum, the array may include pixels corresponding to any number of different colors. According to some implementations in which the color scheme is binary, the first and second pixels 504 may respectively correspond to blue and red (or other colors). In some implementations in which the color scheme is ternary (e.g., RGB), the first, second, and third pixels 504 may respectively correspond to red, green, and blue (or other colors). In some implementations in which the color scheme is quaternion (e.g., CMYK), the first, second, third, and fourth pixels 504 may respectively correspond to cyan, magenta, yellow, and black (or other colors). Although certain color schemes are described above, it will be appreciated that other color schemes are contemplated and are within the scope of the disclosure.

In the array, pixels 504 may be arranged in a motif. Generally speaking, a motif may describe a distinctive and recurring pattern. According to some implementations, first pixels 504 and second pixels 504 may be arranged in a motif such that individual ones of first pixels 504 are positioned adjacent to individual ones of second pixels 104. In implementations having third pixels 504, they may be arranged in the motif such that individual ones of third pixels 504 are positioned adjacent to individual ones of first pixels 504 and individual ones of second pixels 504. In implementations having fourth pixels 504, they may be arranged in the motif such that individual ones of fourth pixels 504 are positioned adjacent to individual ones of first pixels 504, individual ones of second pixels 504, and individual ones of third pixels 104. In some implementations, similar pixels may not be positioned adjacent to each other (e.g., no two first pixels positioned adjacent to each other). Although pixels 504 may be arranged in a motif, as discussed above, this should not be viewed as limiting as other arrangements are contemplated and are within the scope of the disclosure. For example, pixels 504 may be arranged randomly in the array. As another example, multiple different motifs may be used such that pixels 504 in some areas of the array are arranged in a first motif and pixels 504 in other areas of the array are arranged in a second motif.

Individual optical structures of sub-pixels 506 may be configured (and/or physically structured) to create corresponding surface reliefs/optical structures in a substrate that reflect and/or transmit light meeting one or more conditions. For example, a given pixel 504 may include a first sub-pixel 506 and a second sub-pixel 506. The first sub-pixel 506 may include an optical structure configured to create surface reliefs/optical structures in a substrate that reflect and/or transmit light meeting a first condition. The second sub-pixel 506 may include an optical structure configured to create surface reliefs/optical structures in a substrate that reflect and/or transmit light meeting a second condition. The first condition may be different from the second condition. The light reflected and/or transmitted by surface reliefs formed in a substrate by the first sub-pixel 506 and the second sub-pixel 506 may be the corresponding color of the given pixel 504. The given pixel 504 may include a third sub-pixel 106 and a fourth sub-pixel 506. The third sub-pixel 506 may include an optical structure configured to create surface reliefs/optical structures in a substrate that reflect and/or transmit light meeting a third condition. The fourth sub-pixel 506 may include an optical structure configured to create surface reliefs/optical structures in a substrate that reflect and/or transmit light meeting a fourth condition. The light reflected and/or transmitted by the surface reliefs/optical structures created in a substrate that third sub-pixel 506 and the fourth sub-pixel 506 being the corresponding color of the given pixel 506. The third condition may be different from the first condition, the second condition, and the fourth condition. While only four conditions are described here, in some implementations, there may be any number of conditions.

The conditions associated with reflection and/or transmission may include conditions related to one or more of viewing angle, viewing distance, polarization, intensity, scattering, refractive index, birefringence, and/or other conditions. Continuing the example in the above-paragraph, the first condition and the second condition may relate to a first viewing angle. The first condition may be that the light reflected or transmitted by the optical structure of the first sub-pixel 506 is directed toward a left eye of a person observing the substrate from the first viewing angle. The second condition may be that the light reflected or transmitted by the optical structure of the second sub-pixel 506 is directed toward a right eye of the person observing substrate from the first viewing angle. The third condition and the fourth condition may relate to a second viewing angle. The third condition may be that the light reflected or transmitted by the optical structure of the third sub-pixel 5106 is directed toward the left eye of the person observing substrate from the second viewing angle. The fourth condition may be that the light reflected or transmitted by the optical structure of the fourth sub-pixel 506 is directed toward a right eye of the person observing substrate from the second viewing angle. The first viewing angle may be different from the second viewing angle.

Referring again to FIG. 1, image generation component 104 may be configured to heat individual ones of the heating elements 502 of a thermal head 500 according to image 108. The heating elements may form an optical image in a substrate corresponding to the image by forming surface reliefs that form optical structures in the substrate. The optical image may be colored based on the surface reliefs/optical structures formed in the substrate. The optical image may exhibit non-color effects corresponding to other surface reliefs/optical structures formed in the substrate. The non-color effects may give rise to one or more optical effects observable when viewing the optical image. The one or more optical effects may include one or more of a three-dimensional optical effect, a two-dimensional optical effect, a dynamic optical effect, a scattering effect, a holographic white effect, a lens effect, a Fresnel lens effect, a brightness modulation effect, a lithographic effect, a stereogram effect, a nanotext and/or microtext effect, a hidden image effect, a moire effect, a concealed animated pattern effect, a covert laser readable (CLR) effect, a multiple background effect, a pearlescent effect, a true color image effect, a guilloche effect, an animation effect, an achromatic Fresnel effect, a dynamic CLR image, a kinematic images, a full parallax effect, a scratch holographic effect, a polarizing effect, a watermark effect, a metallic effect, a binary optical structure, a Fresnel prism, different viewing distances effect, any rainbow effect, structural colors effects and/or other optical effects.

Individual ones of the sub-pixels formed in the substrate may reflect light at a specific viewing angle with a color. According to some implementations, the optical image may comprise one or more of a hologram, a stereo image, an optically variable device (OVD) based image, a diffractive optically variable image, a zero order device (ZOD) based image, a blazed diffraction structure based image, a first order device (FOZ) based image, a dot matrix image, a pixelgram image, a structural color structure based image, a diffractive identification device (DID) based image, an interference security image structure (ISIS) based image, a kinegram image, an excelgram image, a diffractive optical element based image, a photonic structure based image, a nanohole based image, computer generated holograms, electron-beam generated optical structures, interference patterns, metasurface holograms, plasmonic holograms, tensor holograms, voxel type holograms, quantum holograms, light field holograms, artificial intelligent holograms, structural color structures and/or other optical images.

According to some implementations, a person may view the optical image in the substrate from a specific viewpoint or viewing window (e.g., a range of viewing angles and/or distances). By changing the viewpoint or viewing window (e.g., by moving the optical image relative to the person's eyes), observed colors of the optical image may change due to the reflective properties of the optical structures included in the optical image. The viewpoint or viewing window may be limited in implementations where only the optical structures provide color in the optical image. In order to avoid such a limitation, the optical image may be overprinted with specific colors at corresponding pixels and/or sub-pixels. For example, if the optical image includes two sub-pixels to be viewed as red—one for the right eye and one for the left eye, the viewpoint or viewing window may be relatively small. However, by overprinting those two sub-pixels with a translucent red colored ink, the viewpoint or viewing window may increase because this colored ink maintains the red color with no shift through the rainbow and optical structures of the two sub-pixels keep reflecting light to desired directions. In some implementations, high refractive index lacquers may be used for the purpose of being able to overprint on top with translucent inks and/or lacquers without obliterating pixels and/or sub-pixels. Thus, some implementations may provide optical images having pixels and/or sub-pixels that reflect their particular color but shift throughout the rainbow at different angles, or have a colored filter that helps them extend the viewpoint or viewing window.

In some implementations, the index of refraction of a material making up the optical structures of sub-pixels formed in the substrate may be between approximately 1.4 and approximately 1.6. In some implementations, the high refractive index may be between approximately 1.75 and approximately 2. The high refractive index may be greater than 2.

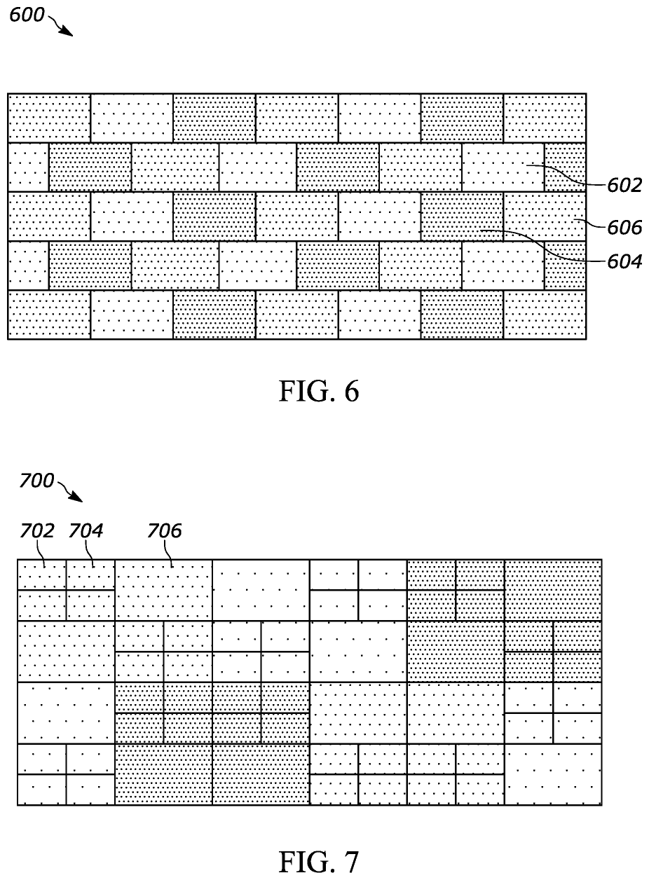

FIG. 6 illustrates an exemplary array 600 of pixels in a heating element 502, in accordance with one or more implementations. As depicted in FIG. 6, array 600 may include pixels corresponding to three different colors. Pixels similar to pixel 602 may correspond to a first color, pixels similar to pixel 604 may correspond to a second color, and pixels similar to pixel 606 may correspond to a third color. Pixels similar to pixel 602, pixels similar to pixel 604, and pixels similar to pixel 606 may be respectively arranged in superimposed hexagonal lattices such that a given pixel is adjacent to pixels of different colors and pixels of a common color are evenly distributed across array 600.

Referring again to FIG. 5, a given pixel 504 may include two or more sub-pixels 506. The sub-pixels 506 may be arranged within a given pixel 504 as one or more of a square lattice, a hexagonal lattice, triangular lattice, rectangular lattice, random or pseudorandom arrangement, and/or other arrangements. Individual ones of sub-pixels 506 may be shaped as a circle, a square, a rectangle, a line, an oval, a rounded square, dots, spirals, patterns, and/or other shapes.

FIG. 7 illustrates an exemplary array 700 of pixels with sub-pixels, in accordance with one or more implementations. As depicted in FIG. 7, a given pixel may include one or more of sub-pixel 702, sub-pixel 704, sub-pixel 706, and/or other sub-pixels. The sub-pixel 702, sub-pixel 704, and/or sub-pixel 706 may be similar or different with respect to optical characteristics and/or physical characteristics. Examples of optical characteristics may include one or more of reflectivity, transmissivity, absorptivity, and/or other optical characteristics. Examples of physical characteristics may include size, shape, and/or other physical characteristics.

Turning again to FIG. 5, individual ones of sub-pixels 506 may correspond to non-color effects. The non-color effects may result from optical characteristics and/or physical characteristics of individual ones of sub-pixels 506. Such non-color effects may be achieved by optical structures included in sub-pixels 506. An optical structure of a given sub-pixel 506 may include one or more of a ruled grating, a laser grating, a photonic grating, an e-beam grating, an ion beam grating, gratings created by nanoholes, a hologram, a three-dimensional nano-structure, a kinegram, a photonic structure, a Fresnel lens, an electron-beam grid, an exelgram, an optical variable device (OVD), a diffractive optically variable image device (DOVID), a zero order device, a pixelgram (e.g., as provided by CSIRO of Australia), a holographic stereogram, a diffraction identification device (DID), a dielectric structure, a volume hologram, a liquid crystal, an interference security image structure (ISIS), a computer-generated hologram, an electron-beam grating, a metasurface hologram, a plasmonic hologram, a tensor hologram, a voxel type hologram, a quantum hologram, a light field hologram, an artificial intelligent hologram, structural color structures and/or other optical structures. In some implementations, a given optical structure may include a physical feature having a linear dimension in the range of 0.01 microns to 1000 microns. In some implementations, optical structures of sub-pixels 506 of a given pixel 504 may be configured such that some reflections/transmissions go to the right eye of a person viewing the substrate and other reflections/transmissions go to the left eye.

Individual optical structures of sub-pixels 506 may be configured (and/or physically structured) to reflect and/or transmit light meeting one or more conditions. For example, a given pixel 504 may include a first sub-pixel 506 and a second sub-pixel 506. The first sub-pixel 506 may include an optical structure configured to reflect and/or transmit light meeting a first condition. The second sub-pixel 506 may include an optical structure configured to reflect and/or transmit light meeting a second condition. The first condition may be different from the second condition. The light reflected and/or transmitted by the first sub-pixel 506 and the second sub-pixel 506 may be the corresponding color of the given pixel 504. The given pixel 504 may include a third sub-pixel 506 and a fourth sub-pixel 506. The third sub-pixel 506 may include an optical structure configured to reflect and/or transmit light meeting a third condition. The fourth sub-pixel 506 may include an optical structure configured to reflect and/or transmit light meeting a fourth condition. The light reflected and/or transmitted by the third sub-pixel 506 and the fourth sub-pixel 506 being the corresponding color of the given pixel 506. The third condition may be different from the first condition, the second condition, and the fourth condition. While only four conditions are described here, in some implementations, there may be any number of conditions.

The conditions associated with reflection and/or transmission may include conditions related to one or more of viewing angle, viewing distance, polarization, intensity, scattering, refractive index, birefringence, and/or other conditions. Continuing the example in the above-paragraph, the first condition and the second condition may relate to a first viewing angle. The first condition may be that the light reflected or transmitted by the optical structure of the substrate with the optical image from the first viewing angle. The second condition may be that the light reflected or transmitted by the optical structure of the second sub-pixel 506 is directed toward a right eye of the person observing the substrate from the first viewing angle. The third condition and the fourth condition may relate to a second viewing angle. The third condition may be that the light reflected or transmitted by the optical structure of the third sub-pixel 506 is directed toward the left eye of the person observing substrate from the second viewing angle. The fourth condition may be that the light reflected or transmitted by the optical structure of the fourth sub-pixel 506 is directed toward a right eye of the person observing substrate from the second viewing angle. The first viewing angle may be different from the second viewing angle.

Continuing the example in the above-paragraph, the first condition and the second condition may relate to a first viewing distance. The first condition may be that the light reflected or transmitted by the optical structure of the first sub-pixel 506 is directed toward the left eye of the person observing substrate from the first viewing distance. The second condition may be that the light reflected or transmitted by the optical structure of the second sub-pixel 506 is directed toward the right eye of the person observing the substrate from the first viewing distance. The third condition and the fourth condition may relate to a second viewing distance. The third condition may be that the light reflected or transmitted by the optical structure of the third sub-pixel 506 is directed toward the left eye of the person observing substrate from the second viewing distance. The fourth condition may be that the light reflected or transmitted by the optical structure of the fourth sub-pixel 506 is directed toward the right eye of the person observing the substrate from the second viewing distance. The first viewing distance may be different from the second viewing distance. In some implementations, images may be created in the substrate that are viewable with only one eye (or viewpoint) such as for dynamic optical effects.

Still continuing the example in the above-paragraph, the first condition and the second condition may relate to polarization. The first condition may be that the light reflected or transmitted by the optical structure of the first sub-pixel 506 has a first polarization. The second condition may be that the light reflected or transmitted by the optical structure of the second sub-pixel 506 has a second polarization. The first polarization may be different from the second polarization.

The pixels 504 may include first pixels 504aa corresponding to a first color and second pixels 504na corresponding to a second color. The sub-pixels 506 may include first sub-pixels 506aa corresponding to a first non-color effect and second sub-pixels 506xa corresponding to a second non-color effect. The geometry is known and the one or more physical processors may be configured by machine-readable instruction to send print instructions to the printer such that the pixels 504 and sub-pixels 506 create desired surface reliefs in desired locations on the substrate.

In this manner, the thermal head pixels 504 and/or sub-pixels 506 may be selectively used to create surface reliefs/optical structures on a substrate to form an optical image corresponding to a base image in an image generation device. The optical image may exhibit different colors corresponding to the pixels 504 and may exhibit non-color effects corresponding to the sub-pixels 506. The non-color effects of the sub-pixels may give rise to one or more optical effects observable when viewing the optical image in the substrate. The one or more optical effects may include one or more of a three-dimensional optical effect, a two-dimensional optical effect, a dynamic optical effect, a scattering effect, a holographic white effect, a lens effect, a Fresnel lens effect, a brightness modulation effect, a lithographic effect, a stereogram effect, a nanotext and/or microtext effect, a hidden image effect, a moire effect, a concealed animated pattern effect, a covert laser readable (CLR) effect, a multiple background effect, a pearlescent effect, a true color image effect, a guilloche effect, an animation effect, an achromatic Fresnel effect, a dynamic CLR image, a kinematic images, a full parallax effect, a scratch holographic effect, a specular effect, a polarizing effect, a watermark effect, a metallic effect, a binary optical structure, a Fresnel prism, different viewing distances effect, any rainbow effect, structural colors effects, and/or other optical effects.

Individual ones of the sub-pixels 506 in the heating element 502 may create surface reliefs/optical structures in the substrate that reflect light at a specific viewing angle with a color corresponding to that of the individual pixels associated with the sub-pixels in the thermal head.

According to some implementations, the optical image may comprise one or more of a hologram, a stereo image, an optically variable device (OVD) based image, a diffractive optically variable image, a zero order device (ZOD) based image, a blazed diffraction structure based image, a first order device (FOZ) based image, a dot matrix image, a pixelgram image, a structural color structure based image, a diffractive identification device (DID) based image, an interference security image structure (ISIS) based image, a kinegram image, an excelgram image, a diffractive optical element based image, a photonic structure based image, a nanohole based image, computer generated holograms, electron-beam generated optical structures, interference patterns, specular and scratch patterns, moire images, light field images, metasurface holograms, plasmonic holograms, tensor holograms, voxel type holograms, quantum holograms, light field holograms, artificial intelligent holograms and structural color structures, and/or other optical images.

According to some implementations, a person may view the optical image from a specific viewpoint or viewing window (e.g., a range of viewing angles and/or distances). By changing the viewpoint or viewing window (e.g., by moving the optical image relative to the person's eyes), observed colors of the optical image may change due to the reflective properties of the optical structures included in the optical image. The viewpoint or viewing window may be limited in implementations where only the optical structures provide color in the optical image.

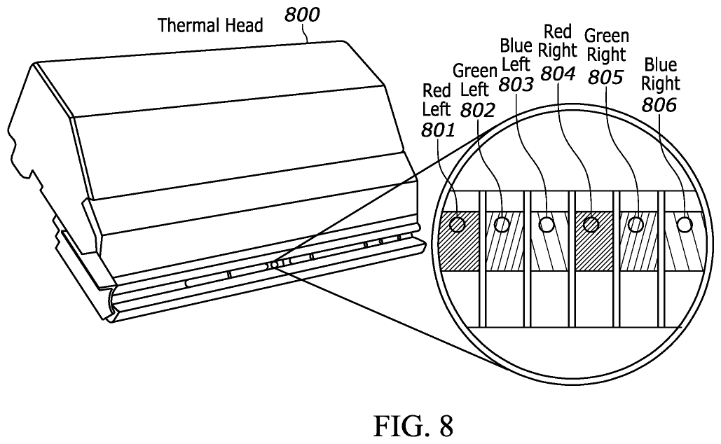

FIG. 8 illustrates schematically, an example of a thermal head 800 that has various pixels for viewing by a person's first eye, (e.g., left eye) and a person's second eye (e.g. right eye). As shown, three pixels create different color effects for the first (or left) eye—a pixel that is red 801, a pixel that is green 802 and a pixel that is blue 803. Similarly, three pixels create different color effects for the second (or right) eye—a pixel that is red 804, a pixel that is green 805 and a pixel that is blue 806. Pixels and sub-pixels that create other colors and effects can also be used and created in the thermal head

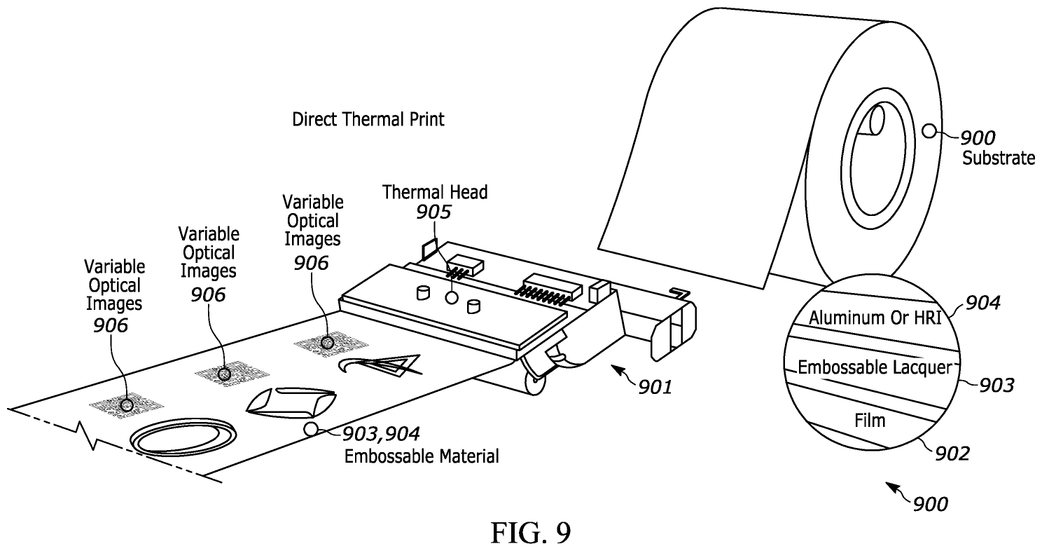

Referring now to FIG. 9, an image formed in a substrate 900 by a direct thermal printer 901 is shown, in accordance with one or more implementations.

A substrate 900 which, as shown, includes a film 902 carrying embossable layers or an embossable coating made of an embossable lacquer layer 903 and an aluminum or HRI coating 904. As the substrate 900, passes through a thermal printer 901 in the proper orientation such that the embossable layers or coating (as shown, the embossable lacquer layer 903 and aluminum or HRI coating 904) can be contacted by the thermal head 905 so that one of more images 906 may be created on the substrate. The images 906 may be continuous, or, as shown, may be variable. When the images 906 are variable, the optical images may vary from print to print. This may make it possible for the printing equipment to print different digital optical images as the substrate passes through the printing equipment. In contrast to conventional techniques, exemplary implementations may digitally vary the ink printing and/or vary the optical images. By way of non-limiting example, one may print 10,000 labels in which an optical image is different on every label. This may enable greater security in industrial labeling and packaging, as well as in security documents such as driver's licenses, passports, paper currency, lottery tickets, government documents, and/or other security documents. Some implementations may be applicable to track and trace of products based on the optical variability of codes and/or other information encrypted onto the optical images.

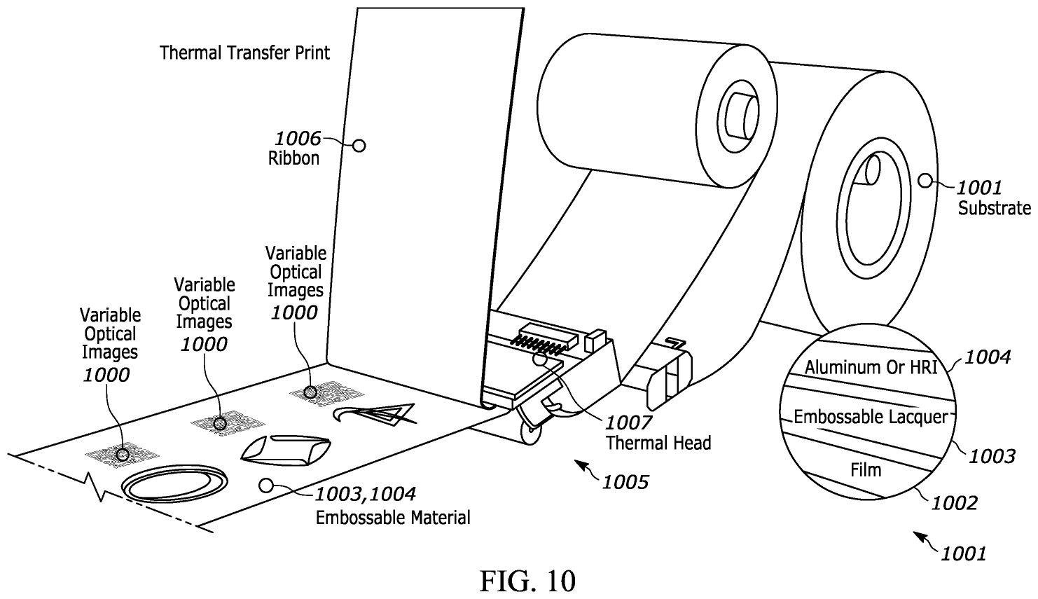

As shown in FIG. 10 an image 1000 formed in a substrate 1001 by a thermal transfer printer 1005 is shown, in accordance with one or more implementations.

A substrate 1001 which, as shown, includes a film 1002 carrying embossable layers or an embossable coating made of an embossable lacquer layer 1003 and an aluminum or HRI coating 1004. As a substrate 1001 passes through a thermal transfer printer 1005 in the proper orientation such that the embossable layers or coating (as shown, the embossable lacquer layer 1003 and aluminum or HRI coating 1004) can be contacted by the transfer ribbon 1006 so that one or more images 1000 may be created on the substrate 1001. The images 1000 may be continuous, or, as shown, may be variable. When the images 1000 are variable, the optical images may vary from print to print. This may make it possible for the printing equipment to print different digital optical images as the substrate passes through the printing equipment. In contrast to conventional techniques, exemplary implementations may digitally vary the ink printing and/or vary the optical images. By way of non-limiting example, one may print 10,000 labels in which an optical image is different on every label. This may enable greater security in industrial labeling and packaging, as well as in security documents such as driver's licenses, passports, paper currency, lottery tickets, government documents, and/or other security documents. Some implementations may be applicable to track and trace of products based on the optical variability of codes and/or other information encrypted onto the optical images.

Alternatively, or in addition, in a thermal transfer printer 1005, the thermal ribbon 1006 may have surface reliefs that form optical elements and may be used to create optical images in the substrate 1001 without the need to have surface reliefs in the thermal head 1007. The structure of the surface reliefs in the ribbon 1006 can be similar to those described above as the pixels and sub-pixels in the thermal head 1007 or may be a generic optical matrix of pixels and sub-pixels. The thermal transfer ribbon 1006 can have surface reliefs that form optical structures, such as pre-embossed RGB optical elements, and can be used to create optical images in a substrate 1001, with or without surface reliefs in the thermal head 1007. The thermal head 1007 will transfer only the needed pixels and sub-pixels from the ribbon 1006 to the substrate 1001 to form an image 1000.

Alternatively, or in addition, thermal heads 1007 of existing thermal print systems have unintended surface reliefs or gratings formed therein. It has been discovered that an embossable substrate 1001 can be used in existing thermal printers such that the surface reliefs or gratings on the thermal heads 1007 can be used to create or replicate surface reliefs in the substrate 1001 which generate images with 2D and single color holographic effects. The holographic effects are obtained when the substrate 1001 is fed into the printer 1005 in an orientation such that the substrate's 1001 embossable area (e.g., embossable lacquer) 1003 in contact (directly or indirectly) with the thermal head 1007.

The image being in an electronic format may facilitate a number of techniques for producing optical images. Examples of electronic formats may include one or more of JPEG, TIFF, GIF, BMP, PNG, DDS, TARGA, DWG, PRT, CMX, EPS, SVG, STL, ART, AI, PSD, PMD, QXD, DOC, 3DS, BLEND, DFF, FBX, MA, MAX, SKP, VRML, BAT, JSFL, CLS, JAVA, MPEG, RM, SWF, PAGES, PCX, PDD, SCT, DXF, DWF, SLDASM, WRL, and/or other electronic formats.

The image in an electronic format may be modifiable such that successively generated optical images are variable in that individual optical images are different from other optical images. For example, the optical image and the successive optical images may include a variable code that is different for different optical images. Examples off the variable codes may include one or more of a linear barcode, a matrix barcode (e.g., a QR code), an alphanumeric code, a graphical code, a 2D code, sequential barcodes, sequential numbers, an encrypted code, a datamatrix code, a matrix 2D code, an Aztec code, a moire code, invisible encrypted codes, a maxi code, and/or other variable codes. The optical image and the successive optical images may include a variable overt security feature and/or a variable covert security feature. An overt security feature may be configured to be used to identify an original document (or other object) by sight and/or touch. A covert security feature may become apparent when a document (or other object) is photocopied or scanned. That is, an additional action is required to activate a covert security feature.

Some implementations may be used in optical encoding. Codes may be variable in that they may include one or more of variable data, sequential numbers, variable codes, variable bar codes, variable images, optically variable matrix barcodes (e.g., QR codes), 2D codes, barcodes, sequential numbers, moire codes, variable databases, and/or other information. Some implementations may be used for tracking purposes. Codes may be encrypted or unencrypted. In some implementations, objects or products may be encoded with sequentially variable optical images. This may add an extra layer of security due to the fact that these optical images may also have sequentially hidden security characteristics. Even without the characteristic of optical hidden security, exemplary embodiments used with encoding offer a layer of security to the object or product that is impossible to duplicate on conventional printing equipment.

By way of non-limiting example, an image may be embossed or engraved on a substrate, which may be used for labels. Such labels may be delivered to a consumer, who in turn may apply them to their objects or products. Once the substrate passes through a thermal printer, the generation of images may occur based on digital information provided to the thermal head. The thermal head may form optical structures of the image by causing the heated thermal head with heating elements with optical structures, such as gratings or other optical structures, corresponding to desired pixels or sub-pixels to emboss or engrave the optical reliefs and image in the substrate. The result may be that, as the substrate travels through the thermal printer, an encoding system available in the marketplace may create optical images in accordance with one or more implementations in the substrate and, at the same time, these images can be sequentially optically variable.

As mentioned above connection with FIG. 1, image component 102 may include electronic storage configured to store the image or a negative of the image in an electronic format (e.g., in implementations in which image 106 is in an electronic format). Electronic storage may comprise non-transitory storage media that electronically stores information. The electronic storage media of electronic storage may include one or both of system storage that is provided integrally (i.e., substantially non-removable) with a computing device and/or printing apparatus and/or removable storage that is removably connectable to a computing device and/or printing apparatus via, for example, a port (e.g., a USB port, a firewire port, etc.) or a drive (e.g., a disk drive, etc.). Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage may include one or more virtual storage resources (e.g., cloud storage, a virtual private network, and/or other virtual storage resources). Electronic storage may store software algorithms, information determined by processor(s), information received from a computing device and/or printing apparatus, and/or other information that enables image component 102 to function as described herein.

The image component 102 may include one or more processors configured to provide processing capabilities. The one or more processors may be configured to provide information associated with the image to one or more other components of system 100 (e.g., in implementations in which image 108 is in an electronic format). Examples of such information may include printing instructions to print the image, instructions to copy or store the image, instructions to change or modify the negative (e.g., change a value of a code on the image), and/or other information. The processor(s) may include one or more of a digital processor, an analog processor, a digital circuit designed to process information, an analog circuit designed to process information, a state machine, and/or other mechanisms for electronically processing information. In some implementations, the processor(s) may include a plurality of processing units, which may be physically located within the same device or a plurality of devices operating in coordination. The processor(s) may be configured to execute machine-readable instructions. The processor(s) may be configured to execute machine-readable instructions by software; hardware; firmware; some combination of software, hardware, and/or firmware; and/or other mechanisms for configuring processing capabilities on the processor(s).

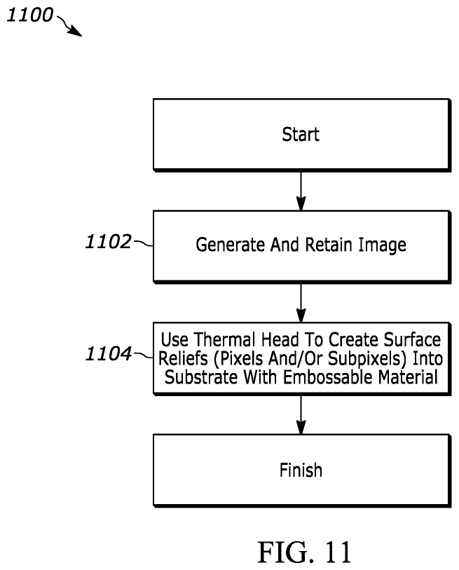

FIG. 11 illustrates a method 1100 for fabricating variable digital optical images using thermal heads in a thermal printer, in accordance with one or more implementations. The operations of method 1100 presented below are intended to be illustrative. In some implementations, method 1100 may be accomplished with one or more additional operations not described, and/or without one or more of the operations discussed. Additionally, the order in which the operations of method 1100 are illustrated in FIG. 11 and described below is not intended to be limiting.

In some implementations, one or more operations of method 1100 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1100 in response to instructions stored electronically on an electronic storage medium. The one or more processing devices may include one or more devices configured through hardware, firmware, and/or software to be specifically designed for execution of one or more of the operations of method.

At an operation 1102, an image (which may be a negative that corresponds to a base image) may be generated and retained. The image may be based on the base image and a geometry associated with the thermal heads heating elements. The thermal heads may have heating elements with surface reliefs corresponding to color (pixels) and surface reliefs corresponding to non-color effects (sub-pixels). The pixels may include first pixels corresponding to a first color and second pixels corresponding to a second color. The sub-pixels may include first sub-pixels corresponding to a first non-color effect and second sub-pixels corresponding to a second non-color effect. The geometry may indicate locations and colors of pixels in the thermal head. The geometry may indicate locations and non-color effects of sub-pixels within the pixels. Operation 802 may be performed by a component that is the same as or similar to image component 102, in accordance with one or more implementations.

At an operation 1104, individual ones of the pixels and/or sub-pixels are formed in the substrate according to the image to form an optical image corresponding to the image in the substrate. The optical image may be colored based on the reliefs formed therein by the pixels. The optical image may exhibit non-color effects based on the reliefs formed therein corresponding to the sub-pixels. Operation 1104 may be performed by an image generation component that is the same as or similar to image generation component 104, in accordance with one or more implementations.

As described above, the pixels may be formed in the substrate using a thermal head with a specific designed pixel/subpixel surface relief configuration, with a thermal head having unintended gratings formed therein or with a thermal ribbon having surface reliefs therein.

One aspect (“aspect 1”) relates to a thermal printer comprising a thermal head comprising an array of heating elements disposed on the thermal head, the array of heating elements including optical structures comprising an array of first pixels corresponding to a first color and second pixels corresponding to a second color, the first color being different from the second color; wherein individual ones of the pixels comprise sub-pixels, a given pixel comprising a first sub-pixel and a second sub-pixel, the first sub-pixel comprising a first optical structure corresponding to light to be reflected or transmitted from a substrate toward a left eye of a person from a first viewing angle, the second sub-pixel comprising a second optical structure corresponding to light to be reflected or transmitted from a substrate toward a right eye of the person from the first viewing angle, and the first sub-pixel and the second sub-pixel correspond to the color of light of the given pixels to be reflected or transmitted from a substrate.

Another aspect (“aspect 2”) relates to aspect 1, wherein a given optical structure includes one or more of a grating, a hologram, a kinegram, a Fresnel lens, a diffractive optically variable image device, a pixelgram, a holographic stereogram, a diffraction identification device, a dielectric structure, a volume hologram, an interference security image structure, a computer-generated hologram, an electron-beam grating, a metasurface hologram, a plasmonic hologram, a tensor hologram, a voxel type holograms a quantum hologram, a light field hologram, an artificial intelligent hologram and/or a structural color structures.

Another aspect (“aspect 3”) relates to a method for fabricating an optical image using a thermal printer that has an array of heating elements with surface reliefs that form a matrix of pixels and sub-pixels, the method comprising obtaining a substrate; forming in the substrate, using a subset of the heating elements, surface reliefs that form an array of pixels in the substrate wherein the array has first pixels corresponding to a first color and second pixels corresponding to a second color, the first color being different from the second color; and forming in the substrate, using a subset of the heating elements, surface reliefs that form sub-pixels within individual ones of the pixels, a given pixel comprising a first sub-pixel and a second sub-pixel, the first sub-pixel comprising a first optical structure configured such that light reflected or transmitted by the first optical structure of the first sub-pixel is directed toward a left eye of a person observing the substrate from the first viewing angle, the second sub-pixel comprising a second optical structure configured such that light reflected or transmitted by the second optical structure of the second sub-pixel is directed toward a right eye of the person observing the substrate from the first viewing angle, the light reflected or transmitted by the first sub-pixel and the second sub-pixel being the corresponding color of the given pixel.

Another aspect (“aspect 4) relates to the method of aspect 3, wherein the array further comprises third pixels corresponding to a third color; the third color is different from the first color and the second color; the given third pixel comprises a third sub-pixel and a fourth sub-pixel; the third sub-pixel comprises a third optical structure configured such that light reflected or transmitted by the third optical structure is directed toward a left eye of a person observing the substrate from a second viewing angle; the fourth sub-pixel comprises a fourth optical structure configured such that light reflected or transmitted by the fourth optical structure is directed toward a right eye of a person observing the substrate from the second viewing angle; and the light reflected or transmitted by the third sub-pixel and the fourth sub-pixel being the corresponding color of the given pixel.

Another aspect (“aspect 5”) relates to a system configured for fabricating variable digital optical images using a thermal head of a thermal printer, the variable digital optical images including different optical images instantly produced in a single printing cycle, the system comprising an image component configured to retain an image, the image being based on a geometry associated with a matrix of surface reliefs in the thermal head, the matrix having an arrayed motif of pixels corresponding to color and sub-pixels corresponding to non-color effects, the pixels including first pixels corresponding to a first color and second pixels corresponding to a second color, the sub-pixels including first sub-pixels corresponding to a first non-color effect and second sub-pixels corresponding to a second non-color effect, the geometry indicating locations and colors of pixels to be formed in an embossable substrate, the geometry further indicating locations and non-color effects of sub-pixels within the pixels, wherein a given non-color effect corresponds to one or more of viewing angle, viewing distance, polarization, intensity, scattering, refractive index, or birefringence; and an image generation component configured to use heating elements in the thermal printer's thermal head to form pixels and/or sub-pixels in the substrate according to the image, the pixels and/or sub-pixels forming an optical image corresponding to the image in the image component.

Another aspect (“aspect 6”) relates to aspect 5, wherein the optical image comprises one or more of a hologram, a stereo image, a hologram, a stereo image, an optically variable device based image, a diffractive optically variable image, a zero order device based image, a blazed diffraction structure based image, a first order device based image, a dot matrix image, a pixelgram image, a structural color structure based image, a diffractive identification device based image, an interference security image structure based image, a kinegram image, an excelgram image, a diffractive optical element based image, a photonic structure based image, a nanohole based image, a computer generated hologram, an electron-beam generated optical structure, an interference pattern, a metasurface hologram, a plasmonic hologram, tensor hologram, a voxel type hologram, a quantum hologram, a light field hologram, an artificial intelligent hologram, or structural color structures.

Another aspect (“aspect 7”) relates to aspect 5, wherein the non-color effects of the sub-pixels give rise to one or more optical effects observable when viewing the optical image, the one or more optical effects including one or more of a three-dimensional optical effect, a two-dimensional optical effect, a dynamic optical effect, a scattering effect, a holographic white effect, a lens effect, a Fresnel lens effect, a brightness modulation effect, a lithographic effect, a stereogram effect, a nanotext and/or microtext effect, a hidden image effect, a moire effect, a concealed animated pattern effect, a covert laser readable (CLR) effect, a multiple background effect, a pearlescent effect, a true color image effect, a guilloche effect, an animation effect, an achromatic Fresnel effect, a dynamic CLR image, a kinematic images, a full parallax effect, a scratch holographic effect, a polarizing effect, a watermark effect, a metallic effect, a binary optical structure, a Fresnel prism, different viewing distances effect, any rainbow effect or structural colors effects.

Another aspect (“aspect 8”) relates to aspect 5, wherein individual ones of the sub-pixels reflect light at a specific viewing angle with a color corresponding to that of the individual pixels associated with the sub-pixels.

Another aspect (“aspect 9”) relates to aspect 5, wherein the optical image and successive optical images include a variable code that is different for different optical images, the variable codes including one or more of a linear barcode, a matrix barcode, an alphanumeric code, a graphical code, a 2D code, sequential barcodes, sequential numbers, an encrypted code, a datamatrix code, a matrix 2D code, an Aztec code, or a maxi code.

Another aspect (“aspect 10”) relates to a thermal printer having a thermal head and a thermal ribbon having pixels corresponding to color and sub-pixels corresponding to non-color effects, comprising an array of pixels disposed on the thermal ribbon, the array comprising first pixels corresponding to a first color and second pixels corresponding to a second color, the first color being different from the second color, the first pixels and second pixels being arranged in a motif; wherein individual ones of the pixels comprise sub-pixels, a given pixel comprising a first sub-pixel and a second sub-pixel, the first sub-pixel comprising a first optical structure corresponding to light to be reflected or transmitted from a substrate toward a left eye of a person from a first viewing angle, the second sub-pixel comprising a second optical structure corresponding to light to be reflected or transmitted from a substrate toward a right eye of the person from the first viewing angle, and the first sub-pixel and the second sub-pixel correspond to the color of light of the given pixels to be reflected or transmitted from a substrate.

Another aspect (“aspect 11”) relates to aspect 10, wherein a given optical structure includes one or more of a grating, a hologram, a kinegram, a Fresnel lens, a diffractive optically variable image device, a pixelgram, a holographic stereogram, a diffraction identification device, a dielectric structure, a volume hologram, an interference security image structure, a computer-generated hologram, an electron-beam grating, a metasurface hologram, a plasmonic hologram, a tensor hologram, a voxel type hologram, a quantum hologram, a light field hologram, an artificial intelligent hologram or structural color structures.

Another aspect (“aspect 12”) relates to method for fabricating an optical image using a thermal printer and thermal head in the thermal head having accessible heating elements with surface reliefs formed thereon, the method comprising obtaining an embossable substrate; feeding the substrate to printer such that an embossable surface of the substrate can be contacted by the surface reliefs of the thermal head's heating elements; identifying heating elements in the thermal head that are to be used to form surface reliefs in the substrate that corresponding to the image; heating the identified heating elements and contacting the substrate with the identified heating elements to form surface reliefs in the substrate.

Another aspect (“aspect 13”) relates to aspect 12 wherein surface reliefs formed in the substrate have pixels and sub-pixels; wherein the pixels formed in the substrate include first pixels corresponding to a first color and second pixels corresponding to a second color, the first color being different from the second color; and wherein sub-pixels within individual ones of the pixels formed in the substrate, include a first sub-pixel and a second sub-pixel and the first sub-pixel comprises a first optical structure configured such that light reflected or transmitted by the first optical structure of the first sub-pixel is directed toward a left eye of a person observing the substrate from the first viewing angle, the second sub-pixel comprising a second optical structure configured such that light reflected or transmitted by the second optical structure of the second sub-pixel is directed toward a right eye of the person observing the substrate from the first viewing angle, the light reflected or transmitted by the first sub-pixel and the second sub-pixel being the corresponding color of the given pixel.

Another aspect (“aspect 14”) relates to a thermal printer, comprising: a thermal head; an array of heating elements disposed on the thermal head; each of the heating elements including surface reliefs comprising an array of first pixels corresponding to a first color and second pixels corresponding to a second color, the first color being different from the second color; wherein individual ones of the pixels additionally comprise surface reliefs that are sub-pixels, a given pixel comprising a first sub-pixel and a second sub-pixel, the first sub-pixel corresponding to light to be reflected or transmitted from a substrate toward a left eye of a person from a first viewing angle, the second sub-pixel comprising surface reliefs corresponding to light to be reflected or transmitted from a substrate toward a right eye of the person from the first viewing angle, and the first sub-pixel and the second sub-pixel correspond to the color of light of the given pixels to be reflected or transmitted from a substrate.

Another aspect (“aspect 15) relates to aspect 14 wherein the surface reliefs form optical structures.

Another aspect (“aspect 16”) relates to aspect 15 wherein a given optical structure includes one or more of a grating, a hologram, a kinegram, a Fresnel lens, a diffractive optically variable image device, a pixelgram, a holographic stereogram, a diffraction identification device, a dielectric structure, a volume hologram, an interference security image structure, a computer-generated hologram, an electron-beam grating, a metasurface hologram, a plasmonic hologram, a tensor hologram, a voxel type holograms, a quantum hologram, a light field holograms, an artificial intelligent hologram or a structural color structure.

Another aspect (“aspect 17”) relates to a substrate having an optical image made by the process of providing a thermal printer with a thermal head, the thermal head having accessible heating elements with surface reliefs formed thereon, obtaining an embossable substrate; feeding the substrate to printer such that an embossable surface of the substrate can be contacted by the surface reliefs of the thermal head's heating elements; identifying heating elements in the thermal head that are to be used to form surface reliefs in the substrate that corresponding to an image to be created in the substrate; heating the identified heating elements and contacting the substrate with the identified heating elements to form surface reliefs that form optical structures in the substrate, wherein the optical structures form the image in the substrate.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

The invention claimed is:

1. A thermal printer, comprising:
a thermal head;
an array of heating elements disposed on the thermal head;
each of the heating elements including optical structures comprising an array of first pixels corresponding to a first color and second pixels corresponding to a second color, the first color being different from the second color; wherein individual ones of the pixels comprise sub-pixels, a given pixel comprising a first sub-pixel and a second sub-pixel, the first sub-pixel comprising a first optical structure corresponding to light to be reflected or transmitted from a substrate toward a left eye of a person from a first viewing angle, the second sub-pixel comprising a second optical structure corresponding to light to be reflected or transmitted from a substrate toward a right eye of the person from the first viewing angle, and the first sub-pixel and the second sub-pixel correspond to the color of light of the given pixels to be reflected or transmitted from a substrate.

2. The thermal printer of claim 1, wherein a given optical structure includes one or more of a grating, a hologram, a kinegram, a Fresnel lens, a diffractive optically variable image device, a pixelgram, a holographic stereogram, a diffraction identification device, a dielectric structure, a volume hologram, an interference security image structure, a computer-generated hologram, an electron-beam grating, a metasurface hologram, a plasmonic hologram, a tensor hologram, a voxel type holograms, a quantum hologram, a light field hologram, an artificial intelligent hologram or structural color structures.

3. A method for fabricating an optical image using a thermal printer that has an array of heating elements with surface reliefs that form an array of pixels and sub-pixels, the method comprising:
obtaining a substrate;
forming in the substrate, using a subset of the heating elements, an array of pixels in the substrate wherein the array has first pixels corresponding to a first color and second pixels corresponding to a second color, the first color being different from the second color; and
forming in the substrate, using a subset of the heating elements, sub-pixels within individual ones of the pixels, a given pixel comprising a first sub-pixel and a second sub-pixel, the first sub-pixel comprising a first optical structure configured such that light reflected or transmitted by the first optical structure of the first sub-pixel is directed toward a left eye of a person observing the substrate from the first viewing angle, the second sub-pixel comprising a second optical structure configured such that light reflected or transmitted by the second optical structure of the second sub-pixel is directed toward a right eye of the person observing the substrate from the first viewing angle, the light reflected or transmitted by the first sub-pixel and the second sub-pixel being the corresponding color of the given pixel.

4. The method of claim 3, wherein:
the array further comprises third pixels corresponding to a third color; the third color is different from the first color and the second color;
the given third pixel comprises a third sub-pixel and a fourth sub-pixel; the third sub-pixel comprises a third optical structure configured such that light reflected or transmitted by the third optical structure is directed toward a left eye of a person observing the substrate from a second viewing angle;
the fourth sub-pixel comprises a fourth optical structure configured such that light reflected or transmitted by the fourth optical structure is directed toward a right eye of a person observing the substrate from the second viewing angle; and
the light reflected or transmitted by the third sub-pixel and the fourth sub-pixel being the corresponding color of the given pixel.

5. A system configured for fabricating variable digital optical images using a thermal head of a thermal printer, the variable digital optical images including different optical images instantly produced in a single printing cycle, the system comprising:
an image component configured to retain an image, the image being based on a geometry associated with a matrix of surface reliefs in the thermal head, the matrix having an arrayed motif of pixels corresponding to color and sub-pixels corresponding to non-color effects, the pixels including first pixels corresponding to a first color and second pixels corresponding to a second color, the sub-pixels including first sub-pixels corresponding to a first non-color effect and second sub-pixels corresponding to a second non-color effect, the geometry indicating locations and colors of pixels to be formed in an embossable substrate, the geometry further indicating locations and non-color effects of sub-pixels within the pixels, wherein a given non-color effect corresponds to one or more of viewing angle, viewing distance, polarization, intensity, scattering, refractive index, or birefringence; and
an image generation component configured to use heating elements in the thermal printer's thermal head to form pixels and/or sub-pixels in the substrate according to the image, the pixels and/or sub-pixels forming an optical image in the substrate corresponding to the image in the image component.

6. The system of claim 5, wherein the optical image comprises one or more of a hologram, a stereo image, a hologram, a stereo image, an optically variable device based image, a diffractive optically variable image, a zero order device based image, a blazed diffraction structure based image, a first order device based image, a dot matrix image, a pixelgram image, a structural color structure based image, a diffractive identification device based image, an interference security image structure based image, a kinegram image, an excelgram image, a diffractive optical element based image, a photonic structure based image, a nanohole based image, a computer generated hologram, an electron-beam generated optical structure, an interference pattern, a metasurface hologram, a plasmonic hologram, a tensor hologram, a voxel type hologram, a quantum hologram, a light field hologram, an artificial intelligent hologram or structural color structures.

7. The system of claim 5, wherein the non-color effects of the sub-pixels give rise to one or more optical effects observable when viewing the optical image, the one or more optical effects including one or more of a three-dimensional optical effect, a two-dimensional optical effect, a dynamic optical effect, a scattering effect, a holographic white effect, a lens effect, a Fresnel lens effect, a brightness modulation effect, a lithographic effect, a stereogram effect, a nanotext and/or microtext effect, a hidden image effect, a moire effect, a concealed animated pattern effect, a covert laser readable (CLR) effect, a multiple background effect, a pearlescent effect, a true color image effect, a guilloche effect, an animation effect, an achromatic Fresnel effect, a dynamic CLR image, a kinematic images, a full parallax effect, a scratch holographic effect, a polarizing effect, a watermark effect, a metallic effect, a binary optical structure, a Fresnel prism, a different viewing distances effect, any rainbow effect or structural colors effects.

8. The system of claim 5, wherein individual ones of the sub-pixels reflect light at a specific viewing angle with a color corresponding to that of the individual pixels associated with the sub-pixels.

9. The system of claim 5, wherein the optical image and successive optical images include a variable code that is different for different optical images, the variable codes including one or more of a linear barcode, a matrix barcode, an alphanumeric code, a graphical code, a 2D code, sequential barcodes, sequential numbers, an encrypted code, a datamatrix code, a matrix 2D code, an Aztec code, or a maxi code.

10. A thermal printer having a thermal head and a thermal ribbon having pixels corresponding to color and sub-pixels corresponding to non-color effects, comprising:
an array of pixels disposed on the thermal ribbon, the array comprising first pixels corresponding to a first color and second pixels corresponding to a second color, the first color being different from the second color, the first pixels and second pixels being arranged in a motif; wherein individual ones of the pixels comprise sub-pixels, a given pixel comprising a first sub-pixel and a second sub-pixel, the first sub-pixel comprising a first optical structure corresponding to light to be reflected or transmitted from a substrate toward a left eye of a person from a first viewing angle, the second sub-pixel comprising a second optical structure corresponding to light to be reflected or transmitted from a substrate toward a right eye of the person from the first viewing angle, and the first sub-pixel and the second sub-pixel correspond to the color of light of the given pixels to be reflected or transmitted from a substrate.

11. The thermal printer of claim 10, wherein a given optical structure includes one or more of a grating, a hologram, a kinegram, a Fresnel lens, a diffractive optically variable image device, a pixelgram, a holographic stereogram, a diffraction identification device, a dielectric structure, a volume hologram, an interference security image structure, a computer-generated hologram, an electron-beam grating, a metasurface hologram, a plasmonic hologram, a tensor hologram, a voxel type hologram, a quantum hologram, a light field hologram, an artificial intelligent hologram or structural color structures.

12. A method for fabricating an optical image using a thermal printer and thermal head in the thermal head having accessible heating elements with surface reliefs formed thereon, the method comprising:
obtaining an embossable substrate;
feeding the substrate to printer such that an embossable surface of the substrate can be contacted by the surface reliefs of the thermal head's heating elements;
identifying heating elements in the thermal head that are to be used to form surface reliefs in the substrate that corresponding to the image;
heating the identified heating elements and contacting the substrate with the identified heating elements to form surface reliefs in the substrate.

13. The method of claim 12, wherein:
surface reliefs formed in the substrate have pixels and sub-pixels;
wherein the pixels formed in the substrate include first pixels corresponding to a first color and second pixels corresponding to a second color, the first color being different from the second color; and
wherein sub-pixels within individual ones of the pixels formed in the substrate, include a first sub-pixel and a second sub-pixel and the first sub-pixel comprises a first optical structure configured such that light reflected or transmitted by the first optical structure of the first sub-pixel is directed toward a left eye of a person observing the substrate from the first viewing angle, the second sub-pixel comprising a second optical structure configured such that light reflected or transmitted by the second optical structure of the second sub-pixel is directed toward a right eye of the person observing the substrate from the first viewing angle, the light reflected or transmitted by the first sub-pixel and the second sub-pixel being the corresponding color of the given pixel.

14. A thermal printer, comprising:
a thermal head;
an array of heating elements disposed on the thermal head;
each of the heating elements including surface reliefs comprising an array of first pixels corresponding to a first color and second pixels corresponding to a second color, the first color being different from the second color; wherein individual ones of the pixels additionally comprise surface reliefs that are sub-pixels, a given pixel comprising a first sub-pixel and a second sub-pixel, the first sub-pixel corresponding to light to be reflected or transmitted from a substrate toward a left eye of a person from a first viewing angle, the second sub-pixel comprising surface reliefs corresponding to light to be reflected or transmitted from a substrate toward a right eye of the person from the first viewing angle, and the first sub-pixel and the second sub-pixel correspond to the color of light of the given pixels to be reflected or transmitted from a substrate.

15. The thermal printer of claim 14, wherein the surface reliefs form optical structures.

16. The thermal printer of claim 15, wherein a given optical structure includes one or more of a grating, a hologram, a kinegram, a Fresnel lens, a diffractive optically variable image device, a pixelgram, a holographic stereogram, a diffraction identification device, a dielectric structure, a volume hologram, an interference security image structure, a computer-generated hologram, an electron-beam grating, a metasurface hologram, a plasmonic hologram, a tensor hologram, a voxel type hologram, a quantum hologram, a light field hologram, an artificial intelligent hologram or structural color structures.
